(19) United States
(12) Patent Application Publication
(10) Pub. No.: US 2026/0200387 A1
(43) Pub. Date: Jul. 16, 2026

(54) DUMP TRAILER

(71) Applicant: American Trailer World Corp., Addison, TX (US)

(72) Inventors: James Blagg, Addison, TX (US); John Terrell, Addison, TX (US); James Deason, Addison, TX (US)

(21) Appl. No.: 19/016,361

(22) Filed: Jan. 10, 2025

(51) Int. Cl. B60P 1/16; B60P 1/28; F15B 15/16

(52) U.S. Cl. CPC B60P 1/16; B60P 1/28; F15B 15/16

(57) ABSTRACT

A dump trailer comprising a frame and a dump box pivotably attached to the frame and configured to actuate between a lowered position and a raised position. The dump box comprises a bottom, a pair of sides, a forward end, and a rearward end that define a payload receiving area. The dump trailer further comprises an actuator extending between the frame and the forward end of the dump box. The actuator is configured to shift the dump box between the lowered and raised positions. A top end of the actuator is positioned below a top surface of the dump box, and a bottom end of the actuator is positioned below the frame.

### BACKGROUND OF THE INVENTION

### Field of the Invention

The present invention relates to trailers with dump boxes for hauling and dumping payloads.

### Description of the Related Art

A towable dump trailer is a trailer that is pulled behind a vehicle (e.g., a semi-truck, heavy-duty truck, pick-up truck, etc.) and hauls a payload, commonly including rock, dirt, refuse, debris, etc. Typically, a dump trailer will include a dump box that is pivotable with respect to a frame of the dump trailer between a lowered position and a raised position. The dump box can securely maintain the payload within the dump box when the dump box is in the lowered position. As such, the dump trailer will generally be transported (e.g., as towed by a vehicle) with the dump box in the lowered position. In contrast, once the dump trailer reaches a dumping location at which the payload is to be removed from the dump trailer, the dump box will be shifted from the lowered position to the raised position such that the payload is “dumped” from the dump box at the dumping location.

Commonly the dump box will be shifted between lowered and raised positions using an actuator, such as a hydraulic cylinder. Because the height by which a dump box must be raised when shifted from the lowered position to the raised position is generally quite significant, the actuator used on a dump trailer is normally required to be quite large in size (e.g., in length). Unfortunately, the large size of an actuator can cause unwanted interferences with the driving clearance of the dump trailer. For instance, if a part of the actuator extends above the top of the dump box, the actuator could unwantedly interfere with overhead road signs, overpasses, bridges, etc., when the dump trailer is being transported. In addition, such large actuators can interfere with the ability for manufacturers of dump trailers stack multiple dump trailers together, as is commonly preferred to efficiently ship multiple dump trailers to a trailer distributor or dealership (e.g., shipping via a semi-trailer, a train car, etc.).

It would, therefore, be advantageous for a dump trailer to be configured with an actuator that is configured to be integrated with a dump box and/or frame of the dump trailer in a manner that reduces the unwanted impact on the clearance of the dump trailer. As such, these particularly configured dump trailers could be (i) transported over roadways without unwanted interference with road obstacles, and (ii) stacked together for efficient shipping of multiple dump trailers simultaneously.

### SUMMARY OF THE INVENTION

One aspect of the present invention concerns a dump trailer comprising a frame and a dump box pivotably attached to the frame and configured to actuate between a lowered position and a raised position. The dump box comprises a bottom, a pair of sides, a forward end, and a rearward end that define a payload receiving area. The dump trailer further comprises an actuator extending between the frame and the forward end of the dump box. The actuator is configured to shift the dump box between the lowered and raised positions. A top end of the actuator is positioned below a top surface of the dump box, and a bottom end of the actuator is positioned below the frame.

Another aspect of the present invention concerns a dump trailer configured to be pulled by a vehicle. The dump trailer comprises a frame and a hitch positioned at a front end of the frame. The hitch is configured to be connected to the vehicle. The dump trailer additionally comprises at least one axle supported by the frame, and a pair of wheels supported on ends of the axle. The wheels are configured to support the dump trailer on the ground. The dump trailer additionally comprises a dump box pivotably attached to the frame and configured to actuate between a lowered position and a raised position. The dump trailer further comprises a hydraulic actuator extending between the frame and a forward end of the dump box. The actuator is configured to shift the dump box between the lowered and raised positions. A top end of the actuator is positioned below a top surface of the dump box, and a bottom end of the actuator is positioned below the frame.

A further aspect of the present invention concerns a method of using a dump trailer. The method comprises a step of supporting a dump box in a lowered position on a frame of the dump trailer. During such supporting step, the dump box holds a payload. The method includes a further step of rotating the dump box with respect to the frame to a raised position. Upon such rotating, the payload is dumped from the dump box. The rotating step is performed by an actuator extending between the frame and a forward end of the dump box. A top end of the actuator is positioned below a top surface of the dump box, and a bottom end of the actuator is positioned below the frame.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE FIGURES

FIG. 1 is a front, upper perspective view of a dump trailer configured according to embodiments of the present invention;

FIG. 2 is a rear, lower perspective view of the dump trailer from FIG. 1;

FIG. 3 is a side elevation view of the dump trailer from FIGS. 1 and 2, with a dump box of the dump trailer in a lowered position;

FIG. 4 is a side elevation view of the dump trailer from FIGS. 1-3, with the dump box of the dump trailer in a raised position;

FIG. 5 is an upper, partial view of the dump trailer from FIGS. 1-4, particularly illustrating a telescopic actuator extending from an actuator support element of a frame of the dump trailer to the dump box of the dump trailer;

FIG. 6 is a lower, partial view of the components of the dump trailer from FIG. 5;

FIG. 7 is an upper view of the telescopic actuator rotatably coupled with the actuator support element from FIGS. 5 and 6, with the telescopic actuator separated from the dump box;

FIG. 8 is a lower view of the telescopic actuator and the actuator support element from FIG. 7;

FIG. 9 is a front perspective view of two dump trailers, as shown in FIGS. 1-4, stacked together for efficient shipping; and

FIG. 10 is a rear perspective view of the two dump trailers stacked together from FIG. 9.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

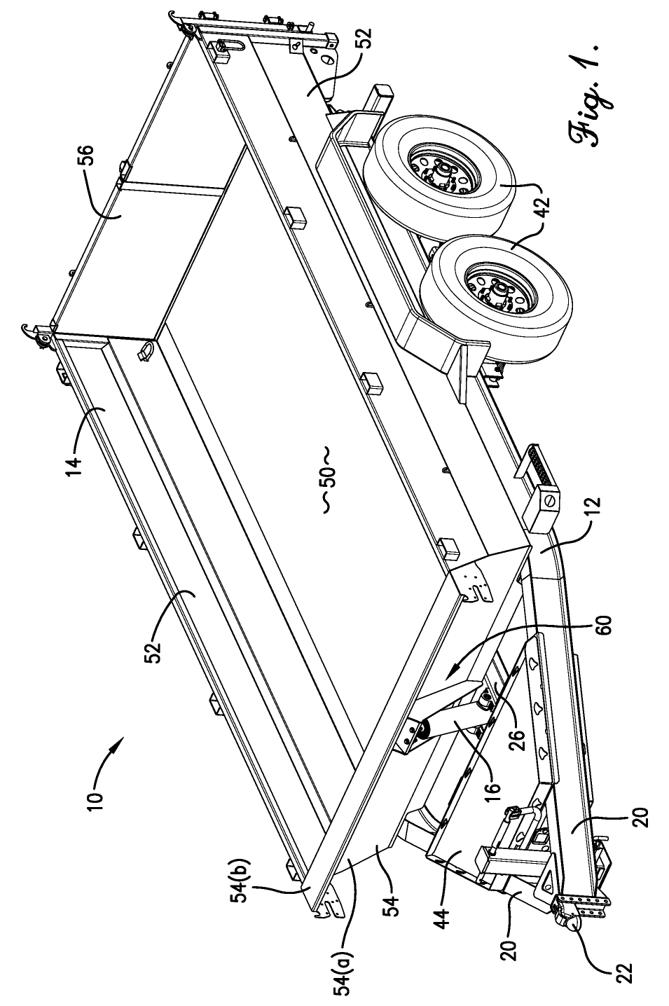

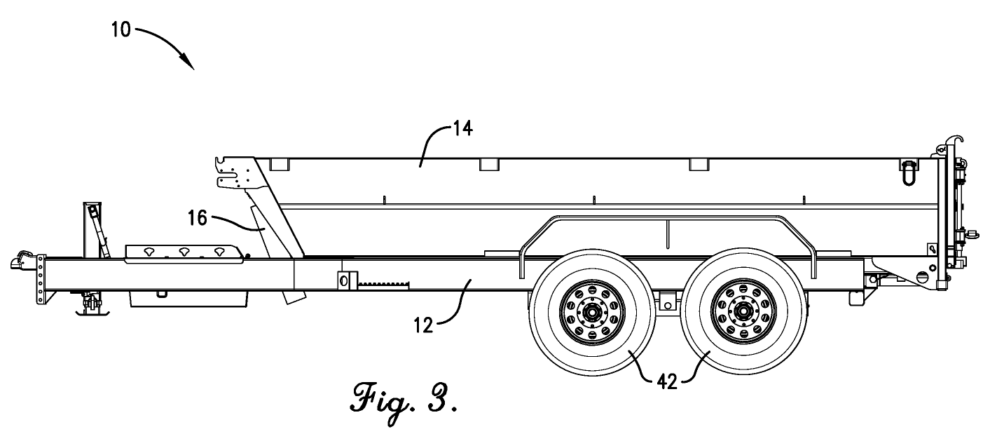

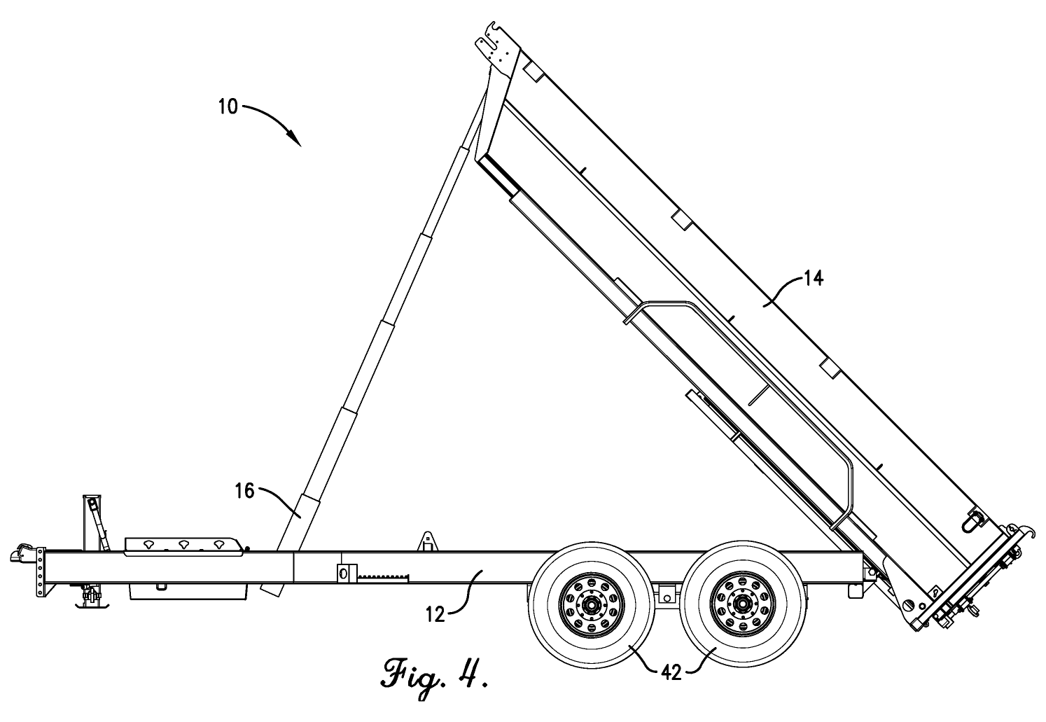

FIGS. 1-4 depict a towable dump trailer 10 configured in accordance with embodiments of the present invention. Broadly, the dump trailer 10 comprises a frame 12 on which a dump box 14 is supported. The dump box 14 may be pivotably connected to the frame 12, such that the dump box 14 can be shifted between a lowered position (see FIG. 3) and a raised position (see FIG. 4). The dump trailer 10 may include an actuator 16 that extends between the frame 12 and the dump box 14 and is configured to actuate the dump box 14 with respect to the frame 12 to shift the dump box 14 between the lowered and raised positions.

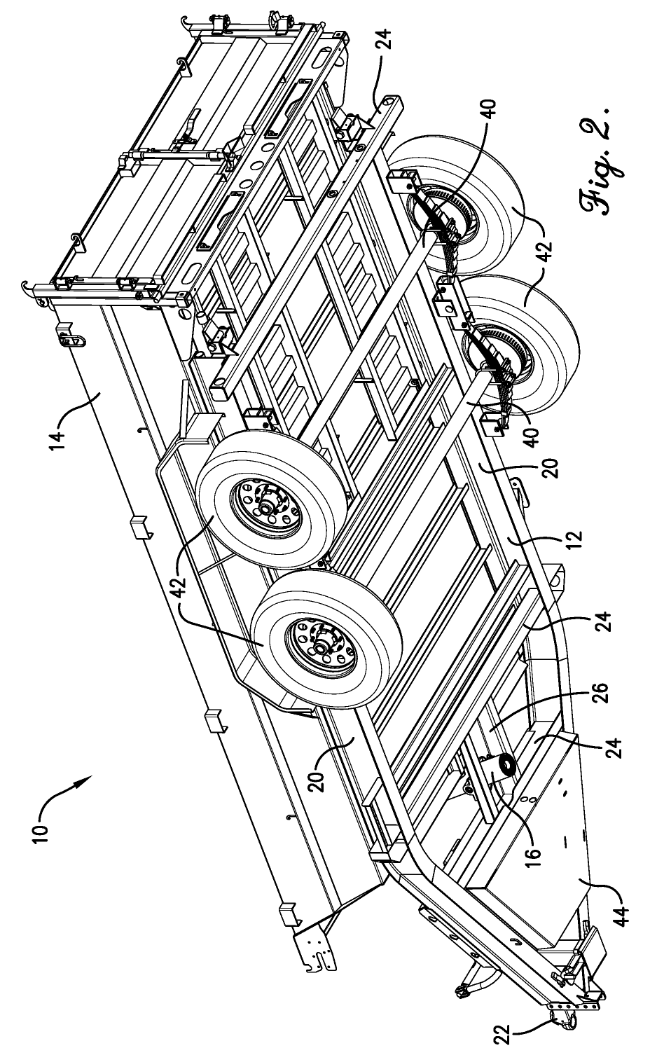

Beginning with the frame 12, as perhaps best illustrated in FIG. 2, the frame 12 comprises a pair of longitudinally extending, outer side rails 20 that extend along a length of the dump trailer 10. The side rails 20 are generally separated by a width of the dump trailer 10 and extend in a generally parallel manner over a main portion of the frame 12. It is noted that the main portion of the frame 12, as such term is used herein, is the portion of the frame 12 on which the dump box 14 is positioned when in the lowered position. At a forward portion of the frame 12, however, the side rails 20 may converge such that the distance between the side rails 20 narrows. Specifically, at the forward portion of the frame 12, the side rails 20 may narrow to a hitch 22 of the dump trailer 10, as shown in FIG. 1 and 2. As such, the hitch 22 is located at the front of the frame 12 and at the front of the dump trailer 10 more generally.

The hitch 22 may comprise various types of hitches (e.g., drop hitch, pintle hitch, gooseneck hitch, fifth-wheel hitch) configured to be releasably secured to a vehicle, such as a semi-truck, heavy-duty truck, pick-up truck, or the like. When connected to the vehicle via the hitch 22, the dump trailer 10 can be pulled by the vehicle over roadways for transport.

Returning to FIG. 2, the frame 12 further comprises a plurality of crossmembers 24 that extend generally laterally between the side rails 20. In some embodiments, the dump box 14 may be rotatably connected to a rearmost one of the crossmembers 24, such that the dump box 14 can rotate between the lowered and raised positions.

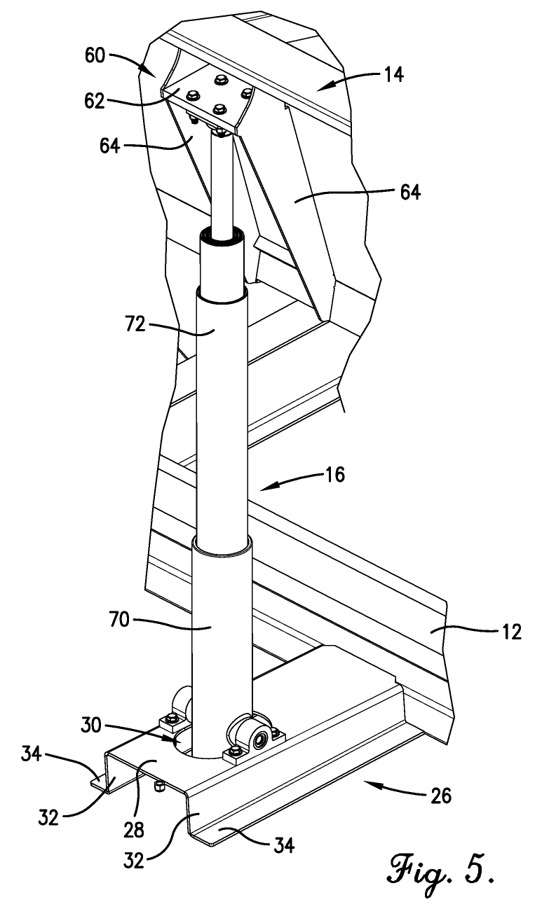

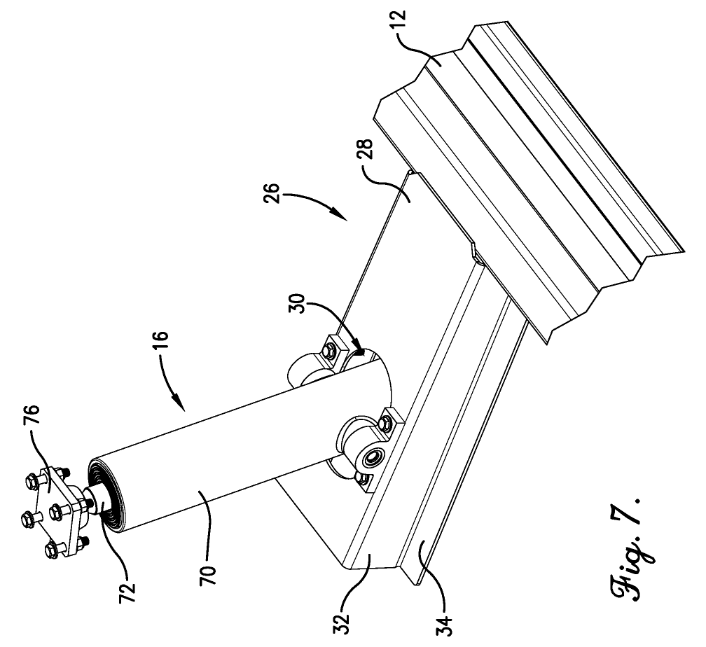

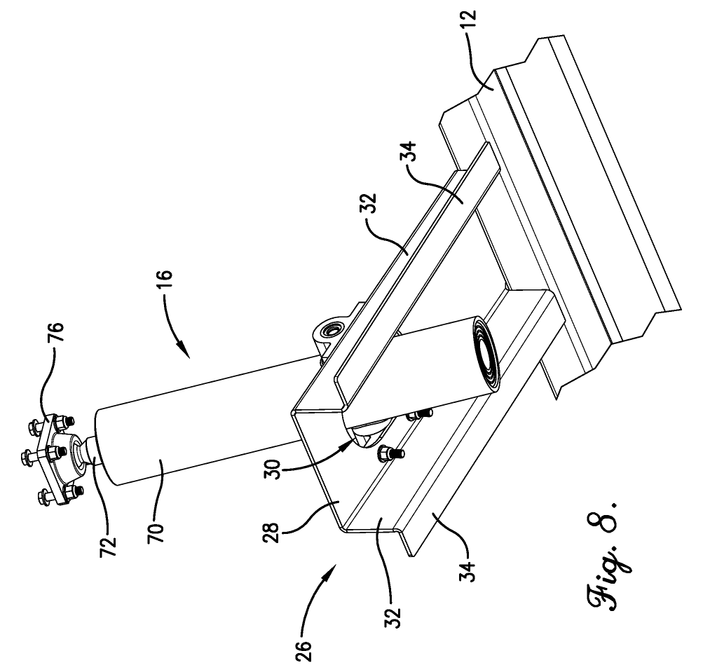

With initial reference to FIGS. 1 and 2, the frame 12 may additionally comprise an actuator support element 26 to which a bottom portion the actuator 16 is pivotably connected. As shown in FIG. 2, the actuator support element 26 may extend longitudinally between two crossmembers 24 of the plurality of crossmembers 24. In some embodiments, the actuator support element 26 may be positioned where the frame 12 transitions between the wide, main portion of the frame 12 to the narrow, forward portion of the frame 12. Regardless, as perhaps best shown in FIGS. 5-8, the actuator support element 26 may comprises a top panel 28 with an opening 30 formed through the top panel 28. In certain embodiments, as will be discussed in more detail below, the bottom end of the actuator 16 will extend down through the opening 30, such that the bottom end or the lower-most end of the actuator 16 extends down below the top panel 28 of the actuator support element 26. The actuator support element 26 may further comprises a pair of side panels 32 that extend downward from the top panel 28 of the actuator support element 26. Each of the side panels 32 may include a bottom flange 34 extending outward from a bottom portion of the respective side panel 32. In certain embodiments, the actuator support element 26 may be rigidly secured to the two supporting crossmembers 24 between which the actuator support element 26 extends via welding at longitudinal ends of the actuator support element 26.

Returning to the dump trailer more generally, as illustrated in FIG. 2, the dump trailer 10 may comprise one or more axles 40 and wheels 42 for movably supporting the dump trailer 10 over the ground. For example, the dump trailer 10 may comprise two axles 40 supported underneath the frame 12, with each of the axles 40 including a wheel 42 positioned on each end of the axle 40. The axles 40 may be configured with various types of suspension elements for supporting the axles 40 and/or wheels 42 with respect to the frame 12. The dump trailer 10 may additionally include fenders for covering the tops of the wheels 42.

Finally, as shown in FIGS. 1 and 2, the forward portion of the frame 12 may support a power box 44 configured to enclose and hold a power system for powering the actuator 16. For example, in embodiments in which the actuator 16 is a hydraulic cylinder, the power system may include a hydraulic reservoir, a hydraulic pump, an electric motor, a battery, various hydraulic valves and lines/hoses, etc. As illustrated in the figures, the power box 44 may be positioned between the hitch 22 and the actuator 16.

Turning to the dump box 14, as perhaps best illustrated in FIG. 1, the dump box 14 may comprises a bottom panel 50, a pair of side panels 52, a forward end 54, and a rearward end 56 that collectively define a payload receiving area in which a payload can be supported when the dump box 14 is in the lowered position. The side panels 52 extend upward from the lateral sides of the bottom panel 50 and also extend longitudinally between the lateral sides of the forward and rearward ends 54, 56. The rearward end 56 of the dump box 14 may comprise a gate, door, or panel that extends upward from the back end of the bottom panel 50 and also extends laterally between the back ends of the side panels 52. The forward end 54 of the dump box 14 may comprise one or more panels that extends upward from the front end of the bottom panel 50 and also extends laterally between the front ends of the side panels 52. The height of the dump box 14 extends from the bottom panel 50 to the upper most edge or surface (i.e., the top surface) of the side panels 52, the forward end 54, and/or the rearward end 56 of the dump box 14. In some embodiments, the height of the dump box 14 may be from 1 to 5 feet, from about 2 feet to about 4 feet, from about 2 feet to about 3 feet, or about 2 feet, or about 3 feet, or about 4 feet, and/or no more than 10 feet, no more than 8 feet, no more than 6 feet, or no more than 5 feet. The length of the dump box 14 (i.e., in a longitudinal direction) may be between 10 and 20 feet, or about 12 feet, or about 14 feet, or about 16 feet.

In some embodiments, the rearward end 56 of the dump box 14 is rotatably coupled with the remaining portions of the dump box 14, such that the gate, door, or panel of the rearward end 56 can rotate to an open position when the dump box 14 is in the raised position to permit the payload held within the payload receiving area to be removed or “dumped” from the dump box. In general, the dump box 14 will be supported on the main portion of the frame 12 when the dump box 14 is in the lowered position. However, the dump box 14 may be rotatably connected to the frame 12, such that a rearward portion of the dump box 14 overhangs the back end of the frame 12. Such an overhang allows for clearance of the rear portion of the dump box 14 to actuate when the dump box 14 shifts between lowered and raised positions.

Turning to the forward end 54 of the dump box 14, the forward end may comprise a main panel 54(a) an overhang lip 54(b) that extends forward from the top of the main panel 54(a) to partially overhang the actuator 16. The main panel 54(a) may extend from the bottom panel 50 in a forward and upward direction. In some specific embodiments, the main panel 54(a) may be oriented at an angle that has a rise to run ratio of about 2:1 (see, e.g., FIG. 3). For example, the main panel 54(a) may extend upward (in a vertical direction) approximately 2 feet, while extending forward (in a forward, longitudinal direction) approximately 1 foot. As will be described in more detail below, such an orientation of the main panel 54(a) may facilitate proper connection and functionality of the actuator 16 to raise and lower the dump box 14.

In some embodiments of the inventive dump trailers, the dump boxes may be formed with larger heights that require for the forward ends to be formed with an additional panel, which is referred to herein as an “upper panel” (not shown in the figures). Such an upper panel may extend from an upper end of the main panel 54(a) in a generally upward (or vertical) direction to the top of the forward end 54. As such, the overhang lip 54(b) may, in such embodiments, extend forward from the top of the upper panel.

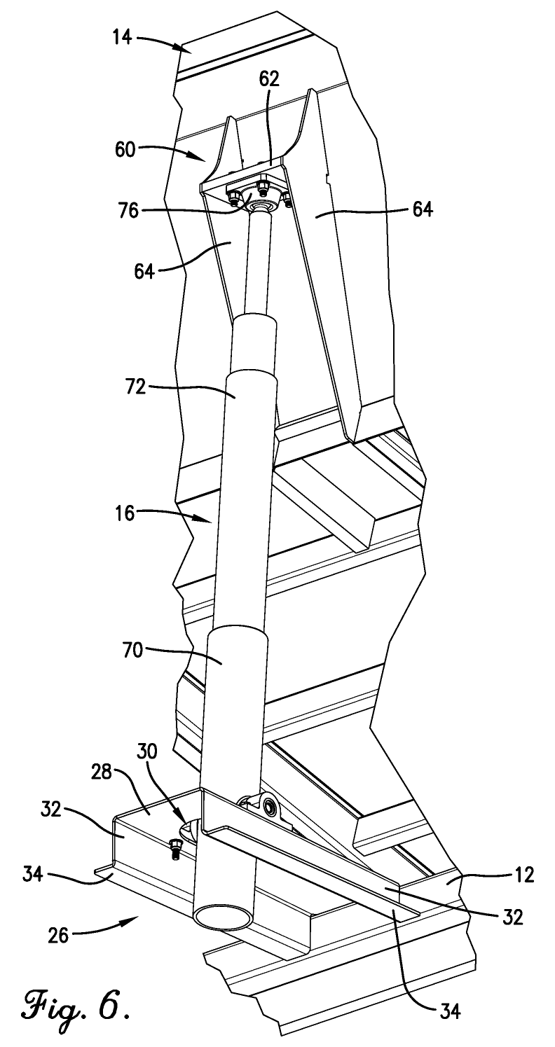

In some embodiments, as initially shown in FIG. 1, the dump box 14 may include an attachment bracket 60 to which an upper end of the actuator 16 may be rotatably coupled. The attachment bracket 60 may be attached to and/or integrated with a front side of the forward end 54 of the dump box 14 and, in some specific embodiments, the main panel 54(a) of the forward end 54. Turning to FIGS. 5 and 6, in some embodiments, the attachment bracket 60 may comprise a base element 62, which may be in the form of a plate that extends forward (in a generally horizontal manner when the dump box is in the lowered position), from the front side of the main panel 54(a) of the forward end 54 of the dump box 14. The attachment bracket 60 may additionally comprise a pair of side support elements 64, which may be in the form of plates that extend upward and/or downward along the front side of the main panel 54(a) of the forward end 54 of the dump box 14 on either side of the base element 62. In some embodiments, the side support elements 64 may extend from a bottom end of the main panel 54(a) to a top end of the main panel 54(a).

Turning to the actuator 16, as noted above, the actuator 16 may extend between the frame 12 and the forward end 54 of the dump box 14, such that actuation of the actuator 16 causes the dump box 14 to shift between lowered and raised positions, as is illustrated in FIGS. 3 and 4. As shown in FIG. 1, the actuator 16 may be centrally aligned with the longitudinal axis of the dump trailer 10 (e.g., centrally aligned with both the frame 12 and the dump box 14). As generally described herein, the actuator 16 may comprise a hydraulic cylinder with, as illustrated in FIGS. 5-8, a barrel 70 and a rod 72 configured to telescopically extend and retract within and/or with respect to the barrel 70. The actuator 16 may be powered by the hydraulic system stored in the power box 44 via one or more hydraulic lines/hoses that extend from the power box 44 to the barrel 70 of the actuator 16. As shown in the figures, the actuator 16 may be positioned with the barrel 70 below the rod 72, such that the rod 72 configured to extend upward from the barrel 70 (i.e., the rod 72 is positioned above the barrel 70). In certain embodiments, the actuator 16 may be a multi-stage hydraulic cylinder, with each stage being indicative of a separately, telescopically extendable portion of the rod 72. For instance, the actuator 16 may be a two-stage cylinder, a three-stage cylinder, a four-stage cylinder, or a five-stage cylinder. As a specific example, as shown in FIG. 4, in embodiments in which the actuator 16 is a five-stage hydraulic cylinder, the rod 72 may comprise five separate portions that are each telescopically extendable or retractable out of or into each other and/or the barrel 70.

The actuator 16 may extend between the frame 12 and the dump box 14 in a manner, such that the barrel 70 is positioned below the rod 72, and the rod 72 telescopically extends in a generally upward direction. The lower portion of the actuator 16 (e.g., the barrel 70) may be rotatably connected to the actuator support element 26 of the frame 12. For instance, as illustrated in FIGS. 5-8, the connection between the actuator 16 and the frame 12 may be in the form of a trunnion connection. A pair of trunnion mounts may be positioned on the top surface of the top panel 28 of the actuator support element 26 on either side of the opening 30 formed through the top panel 28. The barrel 70 may include cylindrical trunnion shafts extending laterally from opposite sides of the barrel 70 for engagement with the trunnion mounts. The trunnion mounts may include roller bearings that permit the shafts, and thus the actuator 16 to rotate or pivot with respect to the actuator support element 26 of the frame 12. As illustrated, the trunnion connection that rotatably secures the actuator 16 to the actuator support element 26 is positioned above the bottom end of the actuator 16.

Beneficially, the bottom end of the actuator 16 (e.g., lowermost portions of the barrel 70) extends down through the opening 30 formed through the top panel 28 of the actuator support element 26. In some embodiments, the opening 30 may have an ovel shape to allow the actuator 16 to rotate while the lower portions of the barrel 70 extend down through the opening 30. The configuration of the bottom end of the actuator 16 (e.g., lower portions of the barrel 70) extending down through the opening 30 beneficially allows for a larger actuator 16 (e.g., having a large/long barrel 70 and/or rod 72) to be used with the dump trailer 10 to allow for the actuator 16 to lift the dump box 14 to a suitable height for dumping when in the raised position. Such beneficial performance of the actuator 16 is achieved without the top end of the actuator 16 extending upward beyond the top surface of the dump box 14, which can interfere with road clearance (e.g., during transport of the dump trailer 10 over roads) and with stacking (e.g., when stacking multiple dump trailers 10 together during shipping of such trailers 10 from a manufacturer). The configuration of the actuator 16 not extending above the top surface of the dump box 14 is achieved, at least partly, due to the bottom end of the actuator 16 extending below the top surface of the actuator support element 26 of the frame 12.

In some embodiments, the bottom end of the actuator 16 will extend down through the opening 30 formed through the top panel 28 of the actuator support element 26 such that the bottom end of the actuator 16 extends below the top panel 28 of the actuator support element 26. However, in some embodiment, although the bottom end of the actuator 16 will extend below the top panel 28 of the actuator support element 26, the bottom end of the actuator 16 may not extend below the bottom of the actuator support element 26 (e.g., below the bottom flanges 34). Instead, the bottom end of the actuator 16 may extend down through the opening 30 of the actuator support element 26 to a position between the top panel 28 and the bottom flanges 34. However, in some other embodiments, the bottom end of the actuator 16 will extend down through the opening 30 of the actuator support element 26 to a position below the bottom of the actuator support element 26 (e.g., below the bottom flanges 34).

In some additional or concurrent embodiments, the bottom end of the actuator 16 may extend below an upper or top surface of the frame 12 of the dump trailer 10. In certain embodiments, the top surface of the frame 12 may be (or include) the top surface of the top panel 28 of the actuator support element 26. In certain embodiment, although the bottom end of the actuator 16 will extend below the top surface of the frame 12, the bottom end of the actuator 16 may not extend below the bottom or bottom surface of the frame 12. Instead, the bottom end of the actuator 16 may extend down through the opening 30 of the actuator support element 26 to a position between the top surface of the frame 12 and the bottom or bottom surface of the frame 12. However, in some other embodiments, the bottom end of the actuator 16 will extend down through the opening 30 of the actuator support element 26 to a position below the bottom or bottom surface of the frame 12. In such embodiments, the bottom end of the actuator 16 extending below the bottom of the frame 12 may mean that the bottom end of the actuator 16 is positioned below the bottom surfaces of the side rails 20 and/or the actuator support element 26 of the frame 12 (see, e.g., FIG. 4). In some embodiments, the bottom end of the actuator 16 may also be positioned below the bottom surfaces of the crossmembers 24. In some embodiments, the bottom end of the actuator 16 will be positioned at least 2 inches, at least 4 inches, at least 6 inches, or at least 10 inches below the frame 12 (e.g., below the bottom surfaces of the side rails 20 and/or the actuator support element 26), and/or no more than 8 inches, no more than 6 inches, no more than 4 inches, or no more than 2 inches below the frame 12 (e.g., below the bottom surfaces of the side rails 20 and/or the actuator support element 26), and/or from 2 to 8 inches, from 4 to 6 inches below the frame 12 (e.g., below the bottom surfaces of the side rails 20 and/or the actuator support element 26).

The top end of the actuator 16 (e.g., the distal end of the rod 72) may be rotatably connected to the dump box 14 via the attachment bracket 60 extending from the front side of the forward end 54 of the dump box 14. Specifically, as shown in FIGS. 6-8, a pivot joint 76 (e.g., a ball joint) may be secured to a bottom of the base element 62 of the attachment bracket 60, and the distal end of the rod 72 may be rotatably coupled with the pivot joint 76. As a result, the actuator 16 is configured to rotate or pivot with respect to the dump box 14. Notably, as was discussed previously, the top end of the actuator 16 (e.g., the distal end of the rod 72) may be positioned below the top surface of the dump box 14, such that the actuator 16 does not extend above the dump box 14 (particularly when the dump box 14 is in the lowered position). In some embodiments, the top surface of the dump box 14 may coincide with the tope surface of the forward end 54 of the dump box 14 (e.g., the top surface of the main panel 54(a) of the upper panel and/or of the overhang lip 54(b)). Correspondingly, the attachment bracket 60 may also be positioned below the top surface of the dump box 14 and/or the top surface of the forward end 54 of the dump box 14. Similarly, the pivot connection between the actuator 16 and the dump box 14 may be positioned below the top surface of the dump box 14 and/or the top surface of the forward end 54 of the dump box 14. Although the above illustrates how the top end of the actuator 16 does not extend above the forward end 54 of the dump box 14, in some embodiments, the top end of the actuator 16 may not extend above the side panels 52 and/or the rearward end 56 of the dump box 14. For example, the top end of the actuator 16 may be positioned below the upper surfaces of the side panels 52, the forward end 54, and/or the rearward end 56 of the dump box 14 (particularly when the dump box 14 is in the lowered position, as shown in FIG. 3).

As perhaps best illustrated in FIG. 3, when the dump box 14 is in the lowered position, the actuator 16 is oriented in general alignment with the lower panel 54(a) of the forward end 54 of the dump box 14. Specifically, the actuator 16 extends in a forward and upward direction from bottom to top, with the barrel 70 of the actuator 16 positioned rearward from the distal end of the rod 72 of the actuator 16. In contrast, as illustrated in FIG. 4, when the dump box 14 is in the raised position, the actuator 16 is rotated to be oriented in a different direction. Specifically, the actuator 16 extends in a rearward and upward direction from bottom to top, with the barrel 70 of the actuator 16 positioned forward of the distal end of the rod 72 of the actuator 16. This change in orientation of the actuator 16 as it telescopically extends allows the dump box 14 to be appropriately raised from the lowered position to the raised position. Notably, the forward and upward extension of the main panel 54(a) of the forward end 54 (from bottom to top when shown in the lowered position of FIG. 3) provides the requisite clearance for the dump box 14 to avoid interference with the actuator 16 during such telescopic extension of the actuator 16 and corresponding raising/lowering of the dump box 14.

Given the configuration of the dump trailer 10 described above, the dump trailer 10 is configured to shift the dump box 14 from a lower position to a raised position with respect to the frame 12 using the actuator 16 that extends between the frame 12 and the forward end 54 of the dump box 14. Beneficially, the actuator 16 is configured to fully lift the dump box 14 from the lowered position to the raised position without the actuator 16 extending above or beyond the top surface of the dump box 14. Such a beneficial condition is permitted, in part, due to actuator 16 being rotatably connected to the frame 12 with the bottom end of the actuator 16 extending down below the top surface of the frame 12, namely, through the opening 30 formed in the top panel 28 of the actuator support element 26 and/or below the frame 12. The ability for the actuator 16 to fully lift the dump box 14 from the lowered position to the raised position without the actuator 16 extending above or beyond the top surface of the dump box 14 may also be facilitated by the actuator 16 being a multi-stage hydraulic cylinder (e.g., a five-stage cylinder).

In view of the above, embodiments of the present invention include a method of stacking two or more dump trailers 10 together for efficient shipping. Each of such dump trailers 10 may comprise a frame 12 and a dump box 14 pivotably attached to the frame 12 and configured to actuate between a lowered position and a raised position. The dump box 14 may comprises a bottom panel 50, a pair of side panels 52, a forward end 54, and a rearward end 56 that define a payload receiving area. The dump trailer 10 may further comprises an actuator 16 extending between the frame 12 and the forward end 54 of the dump box 14. The actuator 16 is configured to shift the dump box 14 between the lowered and raised positions. A top end of the actuator 16 may be positioned below a top surface of the dump box 14, and a bottom end of the actuator 16 may be positioned below an upper surface of the frame 12 or may, in some embodiments, be positioned below the frame 12.

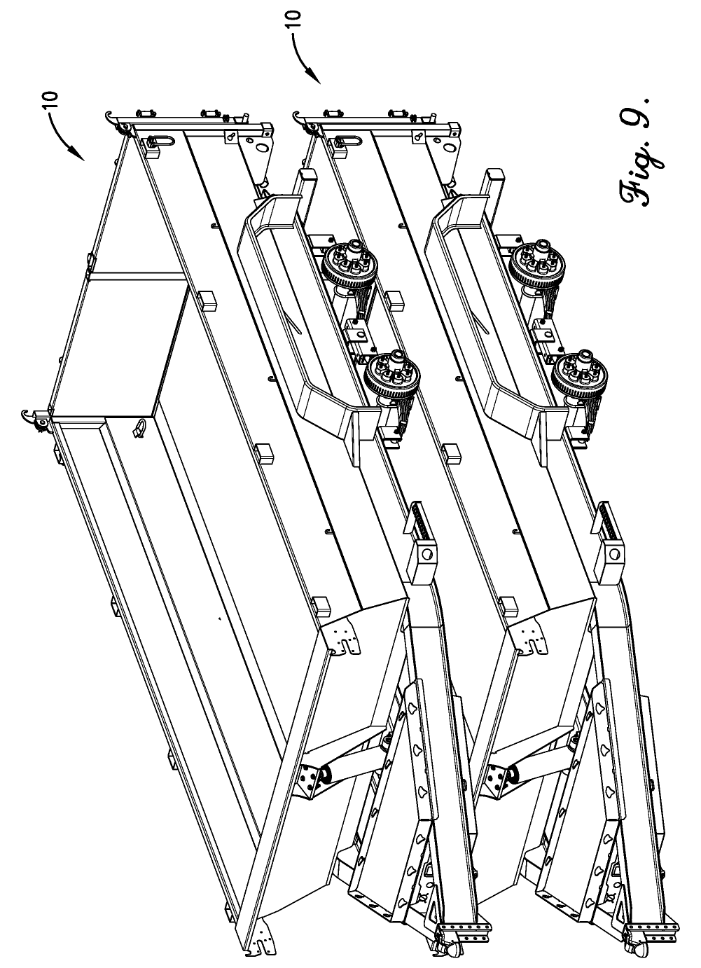

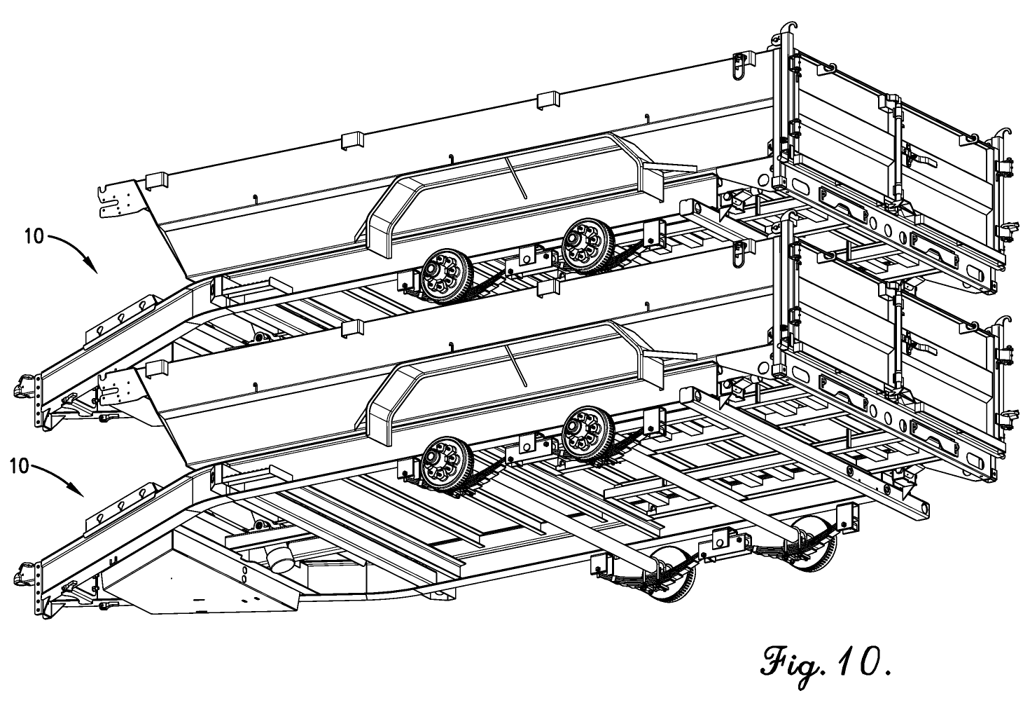

Upon a manufacturer making or assembling two or more dump trailers 10, such dump trailers 10 may be stacked, one on top of the other, to position the two or more dump trailers 10 in an efficient arrangement for shipping or transport. For instance, FIGS. 9 and 10, illustrate two dump trailers 10 stacked together for efficient transport. Notably, the two or more dump trailers 10 can be stacked on top of each other while the actuators 16 are still connected to their respective dump trailers 10; however, because the actuators 16 do not extend above the top surface of their respective dump box 14, the actuators 16 do not interfere with an adjacent dump trailer 16 when the dump trailers 16 are stacked together. The two or more dump trailers 10, once stacked, may be placed on a semi-trailer or train car platform to be efficiently shipped (e.g., to a trailer sales dealership). Because the actuators 16 remain attached to their respective dump trailers 10, time and money can be saved by not having to remove the actuators 16 from the dump trailers 10 before shipping, as well as not having to re-attach the actuators 16 to the dump tailers 10 after shipping.

Such an efficient configuration of the two or more trailers 10 being stacked together is facilitated by the placement of the actuators 16 of the dump trailers 10, and particularly the actuator 16 of a given dump trailer 10 not extending above the top surface of the dump box 14 of the dump trailer 10. As noted previously, such a relative position of the actuator 16 with respect to the dump box 14 may be facilitated by the bottom end of the actuator 16 extending below an upper surface of the frame 12 of the dump trailer 10, extending below the frame 12 of the dump trailer10, and/or by the actuator 16 being a multi-stage hydraulic cylinder. It is noted, however, that in some embodiments, the wheels 42 may be removed from the trailers 10 to aid in facilitating the efficient stacking of two or more dump trailers 10.

Once the dump trailers 10 have been obtained by an end user or operator, the operator may use the dump trailers 10 to haul and dump payloads. For example, a method of using a dump trailer 10 may include a step of supporting a dump box 14 in a lowered position on a frame 12 of the dump trailer 10. During such supporting step, the dump box 14 can hold a payload (e.g., dirt, rock, debris, etc.). As such, the dump trailer 10 can haul the payload over the ground, roadways, etc., as the dump trailer 10 is pulled by a vehicle. Notably, as has been described, a top end of the actuator 16 is positioned below a top surface of the dump box 14, and a bottom end of the actuator 16 is positioned below an upper surface of the frame 12 or below the frame 12. Such a positioning of the actuator 16 increases the clearance of the dump trailer 10 to inhibit potential interference of the dump trailer 10 with roadway obstacles (e.g., road signs, overpasses, etc.). Once the dump trailer 10 has reached an intended dumping area, the method may include a further step of rotating the dump box 14 with respect to the frame 12 to a raised position. Upon such rotating, the payload will be dumped from the dump box 14. The rotating step is performed by an actuator 16 extending between the frame 12 and a forward end 54 of the dump box 14.

### CLAIMS NOT LIMITED TO DISCLOSED EMBODIMENTS

Although specific embodiments of the present technology have been illustrated and described herein. The following claims should not be limited to specific features described and illustrated herein, unless the claims expressly require those specific features. For example, although certain claims may require the actuator to be hydraulic cylinders, claims that simply call for an actuator should not be limited to hydraulic cylinders, but may encompass a wide variety of linear or rotary actuators suitable for actuating the movements of the dump box.

### ADDITIONAL CONSIDERATIONS

As used herein, directional terms are given their standard meaning from the perspective of an operator of the dump trailer 10 standing at the rearward end 56 of the dump box 14 and facing in a forward direction towards the hitch 22 of the dump trailer 10 (i.e., the hitch 22 is positioned at the front of the dump trailer 10). Correspondingly, the dump box 14 is generally supported above the frame 12 of the dump trailer 10 when the dump box 14 is in the lowered position (see, e.g., FIGS. 1-3). And the wheels 42 are positioned on each of the left and right sides of the dump trailer 10.

What is claimed is:

1. A dump trailer comprising:
a frame;
a dump box pivotably attached to the frame and configured to actuate between a lowered position and a raised position, wherein the dump box comprises a bottom, a pair of sides, a forward end, and a rearward end that define a payload receiving area;
an actuator extending between the frame and the forward end of the dump box, wherein the actuator is configured to shift the dump box between the lowered and raised positions,
wherein a top end of the actuator is positioned below a top surface of the dump box, and wherein a bottom end of the actuator is positioned below the frame.

2. The dump trailer of claim 1, wherein the frame comprises an actuator support element to which the actuator is pivotably connected, wherein the actuator support element comprises a top panel with an opening formed through the top panel, wherein the actuator extends through the opening formed through the top panel such that the bottom end of the actuator is positioned below the frame.

3. The dump trailer of claim 2, wherein the frame further comprises a pair of outer side rails and a plurality of crossmembers extending between the side rails, and wherein the actuator support element extends between two supporting crossmembers of the plurality of crossmembers.

4. The dump trailer of claim 3, wherein the actuator support element further comprises a pair of side panels that extend downward from the top panel of the actuator support element, wherein each of the side panels includes a bottom flange extending outward from a bottom portion of the side panel.

5. The dump trailer of claim 4, wherein the bottom end of the actuator is positioned below the bottom flanges of the actuator support element.

6. The dump trailer of claim 2, wherein the actuator is pivotably connected to the actuator support element via a trunnion connection.

7. The dump trailer of claim 6, wherein trunnion connection is positioned above the bottom end of the actuator.

8. The dump trailer of claim 1, wherein the forward end of the dump box includes an attachment bracket to which the top end of the actuator is pivotably connected via a pivot connection.

9. The dump trailer of claim 8, wherein the pivot connection between the actuator and the forward end of the dump box is positioned below a top surface of the forward end of the dump box.

10. The dump trailer of claim 8, wherein the attachment bracket comprises a base element extending forward from the forward end of the dump box and a pair of side supports extending upward and/or downward on either side of the base element, and wherein the actuator is pivotably connected to a bottom of the base element.

11. The dump trailer of claim 1, further comprising:
at least one axle supported by the frame;
a wheel supported on each end of the axle, wherein the wheels are configured to movably support the dump trailer on the ground; and
a hitch positioned at a front end of the frame, wherein the hitch is configured to be connected to a vehicle.

12. The dump trailer of claim 11, further comprising a power box positioned between the forward end of the dump box and the hitch, wherein the power box is configured to store components of a hydraulic system that power the actuator.

13. The dump trailer of claim 12, wherein the actuator comprises a hydraulic cylinder comprising a barrel and a rod configured to extend from and retract within the barrel, wherein the barrel is attached to the frame and the rod is attached to the forward end of the dump box.

14. The dump trailer of claim 13, wherein the actuator comprises a five-stage telescopic actuator.

15. The dump trailer of claim 1, wherein the dump box of the dump trailer has a height from about 2 feet and about 3 feet.

16. A dump trailer configured to be pulled by a vehicle, said dump trailer comprising:
a frame;
a hitch positioned at a front end of the frame, wherein the hitch is configured to be connected to the vehicle;
at least one axle supported by the frame;
a wheel supported on each end of the axle, wherein the wheels are configured to support the dump trailer on the ground;
a dump box pivotably attached to the frame and configured to actuate between a lowered position and a raised position;
a hydraulic actuator extending between the frame and a forward end of the dump box, wherein the actuator is configured to shift the dump box between the lowered and raised positions,
wherein a top end of the actuator is positioned below a top surface of the dump box, and wherein a bottom end of the actuator is positioned below the frame.

17. A method of using a dump trailer, said method comprising:
(a) supporting a dump box in a lowered position on a frame of the dump trailer, wherein during said supporting of step (a) the dump box holds a payload; and(b) rotating the dump box with respect to the frame to a raised position,
wherein upon said rotating of step (b) the payload is dumped from the dump box,
wherein said rotating of step (b) is performed by an actuator extending between the frame and a forward end of the dump box, wherein a top end of the actuator is positioned below a top surface of the dump box, and wherein a bottom end of the actuator is positioned below the frame.

18. The method of claim 17, wherein the frame comprises an actuator support element to which the actuator is pivotably connected, wherein the actuator support element comprises a top panel with an opening formed through the top panel, wherein the actuator extends through the opening formed through the top panel such that the bottom end of the actuator is positioned below the frame.

19. The method of claim 18, wherein the actuator is pivotably connected to the actuator support element via a trunnion connection, and wherein trunnion connection is positioned above the bottom end of the actuator.

20. The method of claim 19, wherein the forward end of the dump box includes an attachment bracket to which the top end of the actuator is pivotably connected via a pivot connection, wherein the attachment bracket comprises a base element extending forward from the forward end of the dump box and a pair of side supports extending upward and/or downward on either side of the base element, and wherein the actuator is pivotably connected to a bottom of the base element.
